(19) United States
(12) Patent Application Publication
(10) Pub. No.: US 2008/0310450 A1
(43) Pub. Date: Dec. 18, 2008

(54) Method of Passing a Constant Bit Rate Digital Signal Through an Ethernet Interface and System for Carrying Out the Method

(75) Inventor: Marzio Gerosa, Vimercate (IT)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/097,309

(22) PCT Filed: Dec. 14, 2006
(86) PCT No.: PCT/EP2006/069699

§ 371 Date: Aug. 22, 2008

(30) Foreign Application Priority Data
Dec. 19, 2005 (EP) 05301072.4

(51) Int. Cl. H04J 3/24

(52) U.S. Cl. 370/474

(57) ABSTRACT

System and method for passing a constant bit rate signal through an Ethernet interface (TX, RX) wherein an original clock rate (102) of the constant bit rate signal (1) is used for transmitting Ethernet packets (2, 3, 4) containing fragments (20, 30, 40) of the constant bit rate signal (1). At reception the original clock rate is recovered, the packets received are broken and the fragments of the constant bit rate signal are recovered and stored in a storage means. The fragments are then read from the storage using the recovered clock rate thus recovering the original rate of constant bit rate signal.

The present invention relates to digital communication within a network in which Ethernet is used. In particular the invention relates to a solution for passing a constant bit rate digital signal through an Ethernet interface in a point to point communication environment.

### BACKGROUND OF THE INVENTION

In general terms, constant bit rate (CBR) refers to a technique of transmitting data streams at a traffic speed that does not change through the time of transmission. The bit rate at transmission end must be the same as the bit rate at reception end. Therefore in order to fulfill this requirement, the task of maintaining the bit rate at a constant level is of importance.

On the other hand, Ethernet is a widely used local area network architecture the specification of which has been defined under IEEE Standard 802.3. Various data transfer rate modalities are known for Ethernet such as the 10 Mbit/s which is the basic data rate, the 100 Mbit/s which is generally known as Fast Ethernet and 1000 Mbit/s generally known as Gigabit Ethernet.

In certain applications such as for example in new generation digital telecommunication equipment which in addition to the usual CBE signals deal with data, a CBR signal may need to be transmitted through a data Ethernet interface. When this is the case, it is needed that some sort of control over the bit rate is provided so that the same bit rate which is generated at the transmission point is available at the reception point.

A known solution for recovering at reception point the same bit rate as generated at transmission point is based on using protocols such as the so-called Pseudo Wire Emulation Edge-to-Edge (PWE3, IETF RFC 3985) and using Real Tile Protocol (RTP, IETF RFC 3550) in order to recover at the reception point, the original clock rate at transmission point. These known solutions are satisfactory when applied to packet switched networks, but they are too complex for use in a simple point to point Ethernet connection where packet switching is absent. Furthermore, a common clock at each end is needed where the maintenance of the signal rate at a constant speed is not guaranteed.

It is therefore desired to provide a solution for passing CBR through an Ethernet interface that would overcome, or substantially reduce the above drawbacks.

### DESCRIPTION OF THE INVENTION

The above objective is achieved by using the solution proposed by the present invention described hereinbelow.

One characteristic of Ethernet transmission is that it is independent of the clocking rate with which it is transmitted, meaning that the transmission may be performed at any convenient clock domain. The invention in its broadest aspect takes advantage of this fact and uses a clock domain based on the original clock rate of the CBR signal for transmitting CBR in Ethernet packets through the Ethernet environment. At destination, the received clock rate is recovered thus recovering with it the original clock rate of the CBR.

In transmission, the original constant bit rate signal is fragmented and inserted into packets. In the following description, this process is referred to as “packaging” and the unit used for performing the process is referred to as “packager”.

In reception, on the contrary, the Ethernet packets are broken into fragments. In the following, this process of breaking the packet into fragments is referred to as “de-packaging” and the corresponding unit for performing it is referred to as “de-packager”.

Thus, by packaging it is meant that the constant bit rate signal, which originally is in the form of a stream of data bits, is broken into fragments of bits and a standard Ethernet header is added to each fragment in order to form a standard Ethernet packet. The resulting packet is transmitted at a clock rate which is locked to the original clock rate of the constant bit rate signal. The resulting standard Ethernet packets then pass through Ethernet interface blocks and are transmitted with the locked clock rate.

In reception, clock recovery is performed and the recovered clock is used for locking a phase locked loop (PLL) at the nominal frequency of the original clock rate of the signal. The Ethernet packets received are then broken and the associated Ethernet headers are eliminated. In this manner the fragments of the original constant bit rate signal are recovered. These fragments are stored in a buffer and can be read at the rate of the PLL which, as stated above, is locked to the original clock rate.

Accordingly, one object of the present invention is that providing a method for transmitting/receiving a constant bit rate signal through an Ethernet interface wherein fragments of the constant bit rate signal are framed into Ethernet packets, the constant bit rate signal having an original clock rate, characterized in that the transmission of the Ethernet packets containing fragments of the constant bit rate signal is made using a clock domain based on the original clock rate of the CBR signal and/or the reception of the Ethernet packets containing the constant bit rate signal is made using a clock domain based on the original clock rate of the CBR signal.

According to an aspect of the present invention, the following steps are provided:
in transmission:
   transmitting an Ethernet packet containing a fragment of the constant bit rate signal and an associated Ethernet header;
   clocking said transmission of Ethernet packet at a rate locked to the original clock rate of the constant bit rate signal.

According to a further aspect of the present invention, the following steps are provided:
in reception:
   breaking the Ethernet packet received and eliminating the associated Ethernet header thus recovering the fragment of the constant bit rate;
   recovering the clock rate of the received packet;
   locking a phase locked loop circuit, with a nominal frequency equal to the original clock rate, to the recovered clock rate; and
   reading the fragment recovered at the rate of said phase locked loop locked to said recovered clock rate.

According to another object of the present invention, there is provided a system for transmitting/receiving a constant bit rate signal through an Ethernet interface wherein fragments of the constant bit rate signal are framed by means of a packager into Ethernet packets, the constant bit rate signal having an original clock rate characterized in that,
the packager is adapted for transmitting the Ethernet packets containing fragments of the constant bit rate signal based on a clock domain of a phase locked loop locked to the original clock rate of the constant bit rate signal; and/or
a de-packager is adapted for receiving the Ethernet packets containing the constant bit rate signal based on a clock domain of a phase locked loop locked to the original clock rate of the constant bit rate signal.

According to still a further aspect of the invention, the packager is adapted for transmitting an Ethernet packet containing a fragment of the constant bit rate signal and an associated Ethernet header, and wherein at transmission said system further comprises a phase locked loop circuit for clocking said transmission of Ethernet packet at a rate locked to the original clock rate of the constant bit rate signal.

According to yet another aspect of the invention, the de-packager is adapted for breaking the Ethernet packet received and eliminating an associated Ethernet header thus recovering the fragment of the constant bit rate signal; and wherein said system further comprises a clock data recovery device for recovering the clock rate of the received packet, a phase locked loop circuit for locking at a nominal frequency of the original clock rate of the signal using the recovered clock rate, and storage means for storing the fragment recovered where said fragment is read at the rate of the phase locked loop locked to said original clock rate.

A further object of the present invention is that of providing a transmitter for use in the system of the present invention.

A still further object of the present invention is that of providing a receiver for use in the system of the present invention.

These and further features and advantages of the present invention are explained in more detail in the following description as well as in the claims with the aid of the accompanying drawings.

### BRIEF DESCRIPTION OF THE DRAWINGS

FIG. 1 is a schematic block diagram representation of an exemplary embodiment of a system for transmitting/receiving a constant bit rate signal through an Ethernet interface according to the present invention.

FIG. 2 is a schematic representation of packaging procedure of a constant bit rate signal into Ethernet packets for use in the system of the present invention.

### EXAMPLE OF A PREFERRED EMBODIMENT

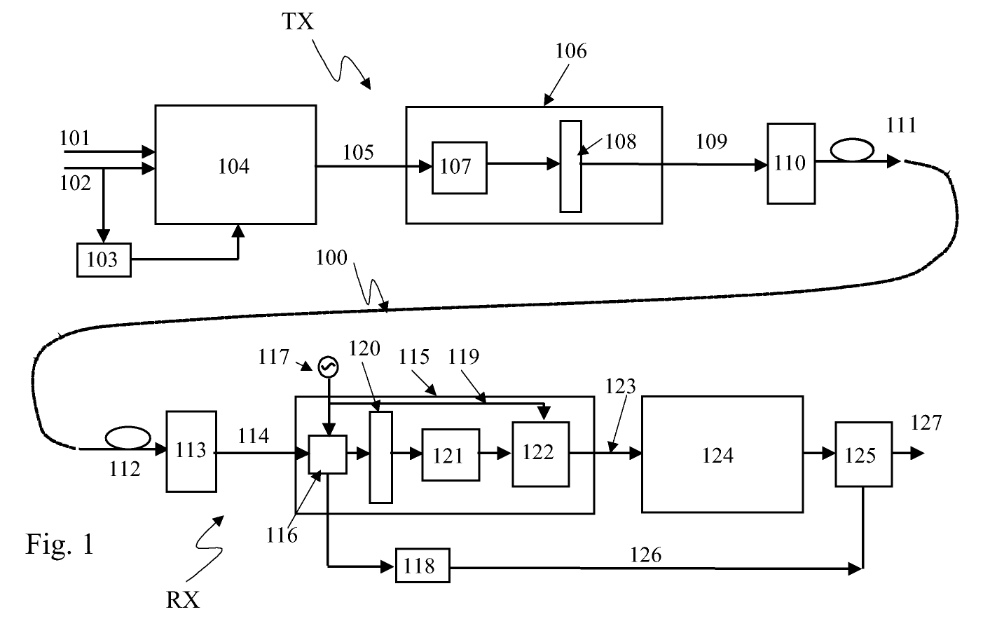

In FIG. 1 an exemplary block diagram of a system for transmitting/receiving a constant bit rate signal having an original clock rate, through an Ethernet interface according to the present invention is shown representing only those parts of the system which are considered helpful for a better understanding of the invention, other parts not shown and known by a person skilled in the related art being considered not relevant for this purpose. In this figure, the upper line of elements shown by the general reference sign TX are related to transmission, and the lower line of elements, shown by the general reference sign RX are related to reception.

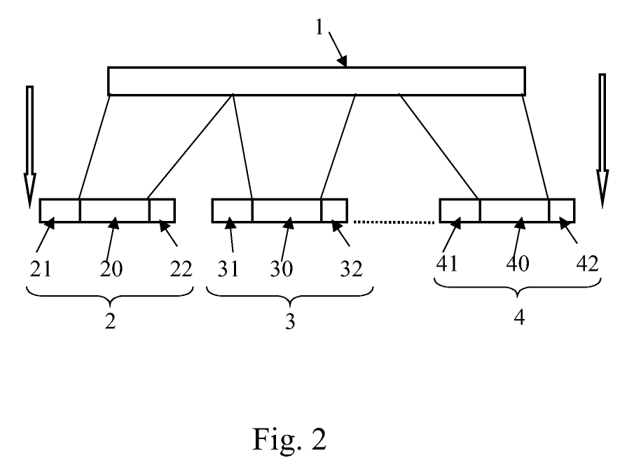

Thus in transmission stage TX, an input signal 101 is shown which is assumed to represent a constant bit rate signal. The signal has an original clock rate, shown by arrow 102. The CBR signal is thus fed into a packager 104. The packager 104 is in charge of breaking the CBR signals into fragments and forming standard Ethernet packets corresponding to each fragment. The process of breaking the CBR signals and forming standard Ethernet packets is schematically shown in FIG. 2.

In FIG. 2 a CBR signal is represented by a single block 1, however it is understood that this block contains a stream of data bits which travel at a constant rate. The CBR signal 1 is then broken (or divided) into fragments 20, 30, 40. Then a standard Ethernet header 21, 31, 41 is added to each respective fragment 20, 30, 40. Using the fragment obtained together with the associated Ethernet header, a standard Ethernet packet may be obtained in which the fragment 20, 30, 40 occupies the payload part of the Ethernet packet. Additional characters or symbols, as conventionally needed in order to complete the standard Ethernet packet, for example a frame check sequence for controlling errors are also included in an appropriate part of the Ethernet packet. This additional part is represented by reference numerals 22, 32 and 42 in each packet. The resulting Ethernet packets are shown in FIG. 2 by reference numerals 2, 3 and 4.

A typical component for performing the packaging operation may be any digital programmable device such as for example the so-called Field Programmable Gate Array (FPGA) or Electrically Programmable Logical Device (EPLD).

Once the Ethernet packets 2, 3, 4 are formed by the packager 104, they are output from the latter. According to the invention and referring back to FIG. 1, the output signal 105 is clocked at a clock rate which is locked to the original clock rate of the CBR signal. In order to achieve this, the original clock rate 102 of the CBR signal is fed to a PLL 103. The PLL 103 uses this bit rate in order to generate a clock signal which is then used as clock for the output signal 105. In this manner, the CBR signal, structured into standard Ethernet packets is suitable for passing through the rest of the elements of transmission while at the same time it maintains a clock rate based on the original clock rate of the CBR.

Next the packets pass through an Ethernet interface unit 106 which may be a conventional unit such as the so-called PHY transmit device (PHY referring to the fact that the interface is related to the physical layer in the OSI layer definition). The interface unit 106 may comprise a coder 107 in order to code the received packets according to a suitable line code, for example the 8b/10b coding for a Gigabit Ethernet application. The interface unit 106 may also comprise a parallel input-serial output (PISO) device 108 in order to generate a serial signal 109 to be output from the interface unit 106. The output signal 109 is then fed to another conventional Ethernet interface device 110 such as the so-called Line Unit Interface (LUI) which in case of use in optical Gigabit Ethernet application may be a Small Form-Factor Pluggable (SFP) which is an optical interface in the form of a transceiver. The output signal 111 thus generated is finally transmitted through the transmission line 100 to the destination point.

In reception RX, at the destination point the signal 111 is received at an input port of a conventional Ethernet LUI device 113 such an SFP (in case of an optical Gigabit Ethernet application) as described above (it is to be noted that LUIs may operate bi-directionally) and a serial interface signal 114 is output from the latter and fed into a second conventional Ethernet interface unit 115 which in this case may be a PHY receive device, also known in the art. In the second interface unit 115, the clock of the received signal is recovered by a clock data recovery device 116. The recovered clock is then fed into a PLL 118, the use of which is described further below.

On the other hand, the clock data recovery device 116 uses a reference clock 117 in order to clock the output of the interface unit 115 as shown by arrow 119.

The serial signal output from the clock data recovery device 116 is fed into a serial input-parallel output (SIPO) device 120 which generates a parallel signal of ten bits to be input into a decoder 121 which is in charge of decoding the received signals, according to a suitable line code, for example the 8b/10b coding for a Gigabit Ethernet application.

The resulting signal is fed into a first input-first output (FIFO) unit 122 which then send the packets 123 to a de-packager 124.

The de-packager 124 is in charge of breaking the Ethernet packets received and eliminating the Ethernet header associated to each packet (21, 31, 41 in FIG. 2) thus recovering the fragments of the original CBR signal (20, 30, 40 in FIG. 2).

Here also, in a similar manner as discussed in relation to the packager, a typical component for performing the de-packaging operation may be any digital programmable device such as for example the so-called Field Programmable Gate Array (FPGA) or Electrically Programmable Logical Device (EPLD).

Once the fragments are available, it is needed to assemble the fragments back together in order to reconstruct the CBR signal. In order to do this, the fragments obtained are stored in an elastic memory 125 such as a buffer. The fragments are then read from the buffer at a rate triggered by the PLL 118 which is sent to the buffer as shown by arrow 126. As mentioned above, the PLL 118 is locked at the nominal frequency of the original clock rate of the CBR.

The resulting signal 127 is thus a CBR signal duly recovered based on the original clock rate of the input CBR 101.

It is to be noted that the choice of interface units 106, 110, 113 and 115 is mentioned in this description as examples for the case of optical Gigabit Ethernet application, in order to provide a better understanding of the invention, and the invention is not to be construed as being limited to the examples given.

It is further to be noted that due to the high capacity of the Ethernet (up to 1 Gb/s), in addition to the standard Ethernet packets as discussed above, additional Ethernet packets (containing different information as compared to the fragments of the original CBR) may be transmitted as well, sharing the same physical connection.

It is therefore appreciated that the recovery of the CBR is achieved by means of a very simple circuitry and by using Ethernet devices which are easily available on the market at relatively low costs.

1. Method for transmitting/receiving a constant bit rate signal through an Ethernet interface wherein fragments of the constant bit rate signal are framed into Ethernet packets, the constant bit rate signal having an original clock rate, characterized in that the transmission of the Ethernet packets containing the fragments of the constant bit rate signal is made using a clock domain based on the original clock rate of the constant bit rate signal and/or the reception of the Ethernet packets containing the fragments of the constant bit rate signal is made using a clock domain based on the original clock rate of the constant bit rate signal.

2. Method according to claim 1, further comprising the steps of: in transmission:
transmitting an Ethernet packet containing a fragment of the constant bit rate signal and an associated Ethernet header;
clocking said transmission of the Ethernet packet at a rate locked to the original clock rate of the constant bit rate signal.

3. Method according to claim 1, further comprising the steps of: in reception:
breaking the Ethernet packet received and eliminating the associated Ethernet header thus recovering the fragment of the constant bit rate;
recovering the clock rate of the received packet;
locking a phase locked loop circuit, with a nominal frequency equal to the original clock rate, to the recovered clock rate; and
reading the fragment recovered at the rate of said phase locked loop locked to said recovered clock rate.

4. System for transmitting/receiving a constant bit rate signal through an Ethernet interface wherein fragments of the constant bit rate signal are framed by means of a packager into Ethernet packets, the constant bit rate signal having an original clock rate characterized in that:
the packager is adapted for transmitting the Ethernet packets containing fragments of the constant bit rate signal based on a clock domain of a phase locked loop locked to the original clock rate of the constant bit rate signal; and/or
a de-packager is adapted for receiving the Ethernet packets containing fragments of the constant bit rate signal based on a clock domain of a phase locked loop locked to the original clock rate of the constant bit rate signal.

5. System according to claim 4 wherein the packager is adapted for transmitting an Ethernet packet containing a fragment of the constant bit rate signal and an associated Ethernet header, and wherein at transmission said system further comprises a phase locked loop circuit for clocking said transmission of Ethernet packet at a rate locked to the original clock rate of the constant bit rate signal.

6. System according to claim 4 wherein the de-packager is adapted for breaking the Ethernet packet received and eliminating an associated Ethernet header thus recovering the fragment of the constant bit rate signal; and wherein said further system comprises a clock data recovery device for recovering the clock rate of the received packet, a phase locked loop circuit for locking at a nominal frequency of the original clock rate of the signal using the recovered clock rate, and storage means for storing the fragment recovered where said fragment is read at the rate of the phase locked loop locked to said original clock rate.

7. Transmitter for use in any one of the systems according to claim 4.

8. Receiver for use in any one of the systems according to claim 4.
